(19) United States
(12) Patent Application Publication
(10) Pub. No.: US 2013/0204780 A1
(43) Pub. Date: Aug. 8, 2013

(54) SYSTEM AND METHOD FOR PURCHASING SOCIALLY

(71) Applicant: SRIRAM KARRI, Hayderabad (IN)

(72) Inventor: SRIRAM KARRI, Hayderabad (IN)

(21) Appl. No.: 13/737,972

(22) Filed: Jan. 10, 2013

(51) Int. Cl. G06Q 20/22

(52) U.S. Cl. CPC G06Q 20/29
USPC 705/40

(57) ABSTRACT

In accordance with an example embodiment a method and system social payment is provided. The method includes receiving a first payment for a purchase from a first user. The first payment comprises a partial payment for the purchase. The method further comprises, electronically sharing information associated with the purchase with at least one user, associated with the first user, to inform the at least one user about incomplete payment for the purchase. The method further includes completing the purchase, socially, by combining part-payments from one or more of other users that are socially connected to the first user.

### TECHNICAL FIELD

The present technology generally relates to purchase payments, and more particularly, relates to payments associated with online e-commerce transactions, offline commerce transactions or mobile-based commerce.

### BACKGROUND

Conventionally, users participating in online e-commerce, offline electronic purchase or mobile-based commerce can close the transactional process of buying by making a single transaction payment of the entire amount, equivalent to the value of the items being purchased. The payment for such purchases can be made by several modes, including credit card, debit card, cash on delivery, gift cards, redemption of loyalty points, and the like. However, there are existing mechanisms where the merchant or the credit card establishment might offer a user a credit facility to make part-payments for the purchases, over a period of time. Typically, however, all payments are made by the user. Part-payment for online and offline purchases can be made using a combination of payment devices, like part cash, part cheque, part credit card, and the like. In the existing form of electronic purchases, typically a single user makes the payments for the purchases either in a single instalment or in multiple part-payments over the period of time.

### SUMMARY OF SOME EMBODIMENTS

This summary is provided to introduce a selection of concepts in a simplified form that are further described below in the detailed description. This summary is not intended to identify key or essential features of the claimed subject matter, nor is it intended to be used as an aid in determining the scope of the claimed subject matter.

In one embodiment, a method comprises receiving a first payment for a purchase from a first user. The first payment comprises a partial payment for the purchase. The method further comprises, electronically sharing information associated with the purchase with at least one user, associated with the first user, to inform the at least one user about incomplete payment for the purchase.

In another embodiment, a non-transitory, computer-readable storage medium storing computer-executable program instructions to implement receiving a first payment for a purchase from a first user. The first payment comprises a partial payment for the purchase. The computer-executable program instructions further implements causing to share information associated with the purchase with at least one user, associated with the first user, to inform the at least one user about incomplete payment for the purchase.

In another embodiment, a system comprises a memory to store instructions. The system further comprises a processor responsive to stored instructions to perform receiving a first payment for a purchase from a first user. The first payment comprises a partial payment for the purchase. The processor is further capable to cause to share information associated with the purchase with at least one user, associated with the first user, to inform the at least one user about incomplete payment for the purchase.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an example of an environment, where various embodiments may be implemented;

FIG. 2 illustrates a block diagram of a system for social payment, in accordance with an exemplary embodiment;

FIGS. 3A and 3B illustrate a schematic representation of interaction of a user with an e-commerce electronic entity and a merchant establishment, respectively to initiate a purchase, in accordance with an exemplary embodiment;

FIGS. 4A and 4B illustrate schematic representations of management of a virtual escrow created based on interaction of the user with the e-commerce electronic entity and the merchant establishment, respectively, in accordance with an exemplary embodiment;

FIG. 5 illustrates a schematic representation of a progress of a social payment, in accordance with an exemplary embodiment;

FIGS. 6A and 6B illustrate schematic representations of successful purchases from e-commerce electronic entity and the merchant establishment, respectively, in accordance with an exemplary embodiment;

FIGS. 7A and 7B illustrate success or failure of purchase from e-commerce electronic entity and the merchant establishment, respectively, in accordance with an exemplary embodiment;

FIG. 8 is a flowchart depicting an exemplary method of the social payment, in accordance with an exemplary embodiment; and

FIG. 9 is a flowchart depicting an exemplary method of the social payment, in accordance with another exemplary embodiment.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

Broadly, embodiments of the present technology disclose a method and system to allow a user to socialize an e-commerce transaction, offline purchase or mobile-based commerce. The user makes partial payment after initiating a process to make the purchase and then invites or requests other users, socially linked to the user or otherwise. The user can communicate with other users using their user identities of online communities, web portals, social networks, email services, e-commerce registered users, web sites or any electronic services to make part-payment, till the entire payment is completed over a period of time. Once the payment for the purchase is completed by combination of partial payment and part-payments, the purchase is granted as sold to the user. The user can initiate the purchase of at least one of an item, product, service, and the like by various embodiments of the present technology.

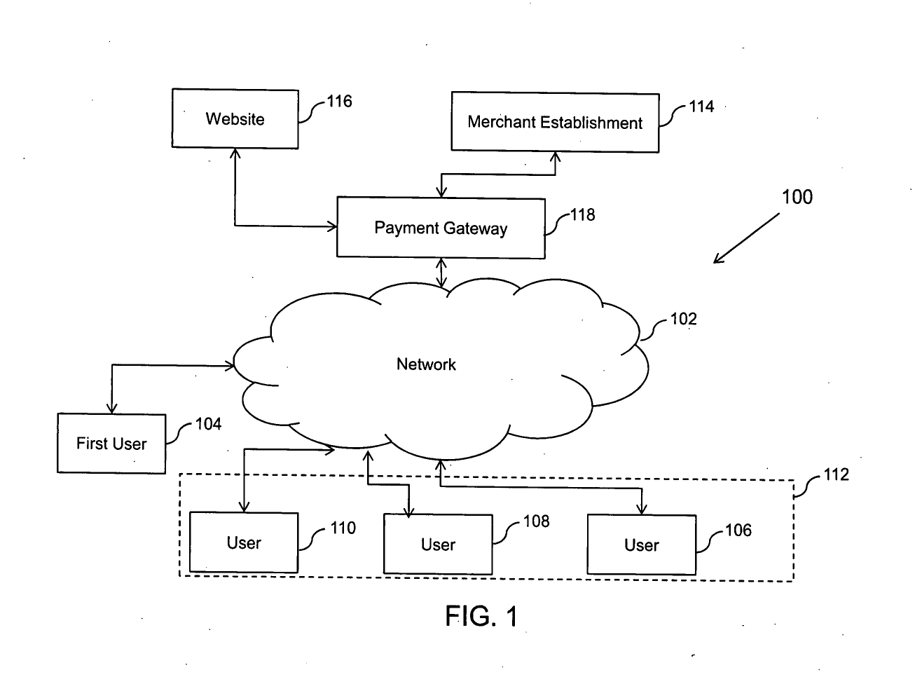

FIG. 1 illustrates an example of an environment 100, where various embodiments of the present technology may be implemented. The environment 100 is a social shopping environment for online e-commerce, offline purchase transactions or mobile-based commerce. The environment 100 (hereinafter also referred to as “social shopping environment 100”) includes a network 102 for communication among a plurality of users, for example a first user 104 and one or more users 106-110. The examples of the network 102 are, but not limited to, Internet, Wide Area Network (WAN), Local Area Network (LAN), and the like. The first user 104 is socially linked to the one or more users 106-110, such as colleagues, friends, relatives, friends on any social network friend, and the like. Further, the first user 104 is communicatively linked to the one or more users 106-110. Examples of the communication link may include, but are not limited to, online community, web portal, social network, email service, blogs, photo and video sharing environment, SMS, web site or any similar electronic service. The one or more users 106-110 can define a group of users 112. The first user 104 and the group of users 112 are communicatively linked with the network 102 through one or more electronic devices. Examples of electronic devices may include, but are not limited to, mobile, laptop, desktop, tablet, personal digital assistance device, palmtop, and the like. It should be understood by a person ordinarily skilled in the art that description of the group of users 112 is exemplary and can have any number of users, communicatively and socially linked with the first user 104. In an embodiment, the number of users in the group of users 112 can be defined and controlled by the first user 104. Further, the first user 104 may permit or prohibit any user to be a part of the group of users 112 associated with the social purchase.

In an embodiment, the first user 104 initiates a first payment for a purchase. The purchase transaction can be an e-commerce or offline purchase transaction of at least one of an item, a product, a service, and the like. The purchase can be through at least one of a seller site, a bid during an auction, a bid during a reverse auction, blind bids, and the like. The first payment is initiated at at least one of a merchant establishment 114 or electronic entity 116; both are communicatively linked to the network 102 through a payment gateway 118. It should be understood that description of the electronic entity 116 is exemplary. Further, the examples of the electronic entity 116 include, but are not limited to, a website, an application, and an electronic service. The first payment is initiated using an identifier associated with the first user 104. In an embodiment, the payment gateway 118 is an acquirer that acquires payment from the first user 104 and the group of users 112 on behalf of the merchant establishment 114 and the electronic entity 116. It should be noted that description of the payment gateway 118 is exemplary and can also be integrated within the merchant establishment 114 and/or the electronic entity 116 in an embodiment of the technology. The payment gateway 118 is further described in the subsequent description.

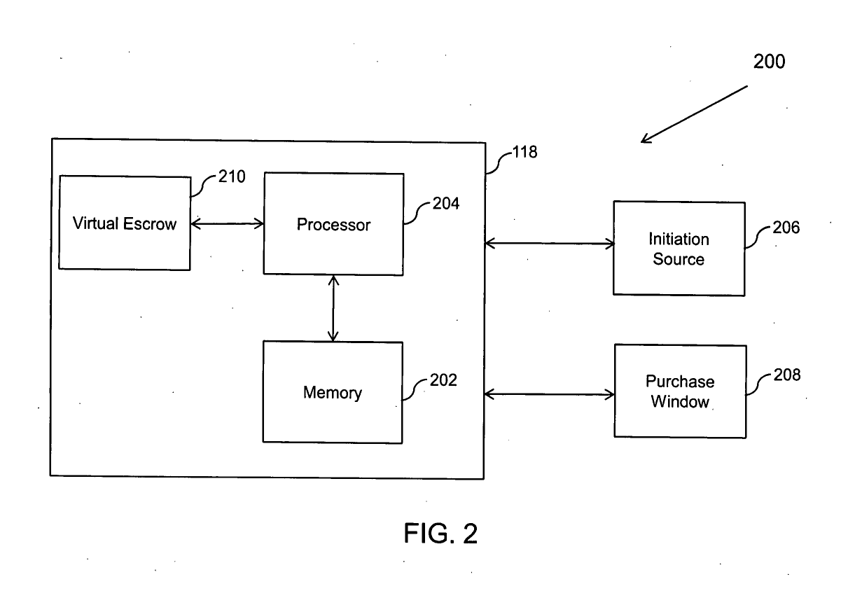

FIG. 2 illustrates a block diagram of a system 200 in accordance with one embodiment of the present technology. The payment gateway 118 includes a memory 202 to store instructions and a processor 204, responsive to instructions stored in the memory 202. The processor 204 receives the first payment for the purchase from the first user 104. The first payment can be done by any one or combination of different modes of payment available to the first user 104. Examples of the different modes of payment may include, but are not limited to, credit card, debit card, online bank transfers, or even cheques, cash, or redemption of virtual credits, merchant credit notes, marketplace credits, discount vouchers, loyalty points, digital currencies, and virtual monies. The first payment includes partial payment, an amount less than the purchase amount, for the purchase. The first payment is initiated using an initiation source 206. The initiation source 206 may be a point of sale of the merchant establishment 114 or the electronic entity 116, or any other source device, where the first user 104 can make the first payment by any mode of payment described above, or from where the first user may initiate the first payment. The processor 204 causes to share information associated with the purchase with at least one user of the group of users 112. The group of users 112 are informed about the incomplete payment for the purchase. The first user 104 can define and control the number of users in the group of users 112, with whom the information about the partial payment is subsequently shared. Further, the first user 104 may permit or prohibit any user to be a part of the group of users 112. The first payment is received by the processor 204 using an identifier associated with the first user 104. Further, the information associated with the purchase is shared with at least one user of the group of users 112 on an electronic entity 116 using the identifier.

The processor 204 creates a purchase window 208 in response to receipt of the first payment through the initiation source 206. Subsequently, the at least one user of the group of users 112 is provided with one or more options to contribute to one or more subsequent part-payments for the purchase, hence setting a framework for social payment. Further, a unique code is assigned for the social payment. The one or more subsequent part-payments by the at least one user of the group of users 112 include partial payment, an amount less than the purchase amount, for the purchase. However, in an embodiment, one or more users of the group of users 112 may also decide not to participate in the social payment. The first user 104 can define and store one or more rules for the one or more subsequent part-payments in the memory 202 for successful social payment. The one or more options are derived from the one or more rules. Examples of the one or more rules may include, but are not limited to, a timeframe for maintaining the purchase window 208, number and identification of users in the group of users 112 to participate in the social payment, number of times the at least one user of the group of users 112 can contribute, fixed amount of allowable one or more subsequent part-payments by the at least one user of the group of users 112, minimum or maximum amount for the one or more subsequent part-payments by the at least one user of the group of users 112, modes and/or one or more possibility of the one or more subsequent part-payments by the at least one user of the one or more users 112, closure of the complete payment, auto-deduct to complete the payment, and beneficiary/recipient of the purchase. In an embodiment, the processor 204 may define the one or more rules and the one or more options. It should be noted that the description of payment gateway 118 is exemplary, and should not be considered as limiting to the scope of the present technology. In an embodiment, the initiation source 206 and the purchase window 208 may be within the payment gateway 118.

The one or more rules can be fixed or amendable by the first user 104 during the social payment. In an embodiment, the one or more rules can be defined before the one or more subsequent part-payments and/or amended during the social payment by the processor 204. In another embodiment, the first user 104 may define or let the at least one user of the group of users 112 define the beneficiary/recipient of the purchase by the social payment. The recipient could be at least one of himself/herself, one or more users of the group of users 112 participating in the social payment, and any person or establishment outside the network 102. For example, the first user 104 and the at least one user of the group of users 112 may participate in the social payment to offer a gift to any other user. In an embodiment, the non-recipient would be benefitted by bonus or loyalty rewards such as points, gifts, coupons etc., awarded by at least one of the merchant establishment 114, the electronic entity 116, and the payment gateway 118 for participation in the social payment. The bonus or loyalty points can be later redeemed by the respective user of the group of users 112 for a purchase. It should be noted that the facility of partial payment might directly be offered as part of an e-commerce electronic entity, a Social Networking, a Blogging site, and the like.

In an embodiment, the processor 204 creates a virtual escrow 210 once the purchase window 208 is created. The virtual escrow 210 is used to hold the first payment by the first user 104 and the one or more subsequent part-payments by the at least one user of the group of users 112 till the purchase is completed. Once the purchase is completed, the complete payment amount is submitted with the merchant establishment 114 and/or the electronic entity 116. In return, the payment gateway 118 may charge a fee proportional to the purchase amount from the merchant establishment 114 and/or the electronic entity 116. Further embodiments of the system 200 entities would be described in subsequent figures.

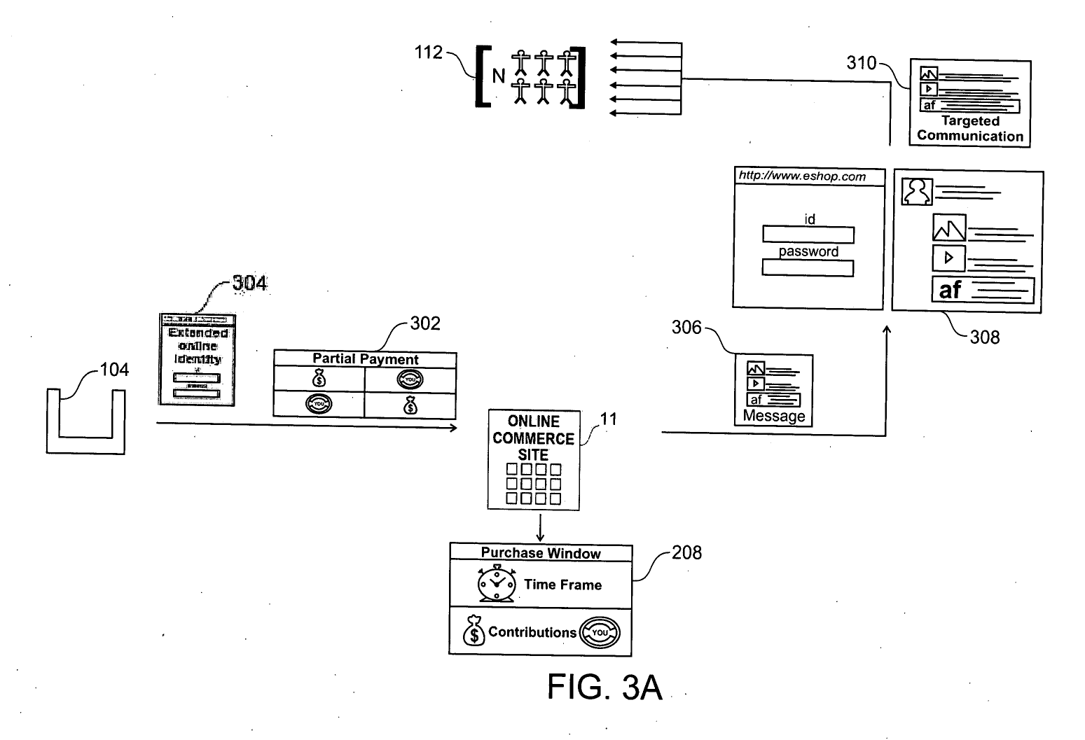

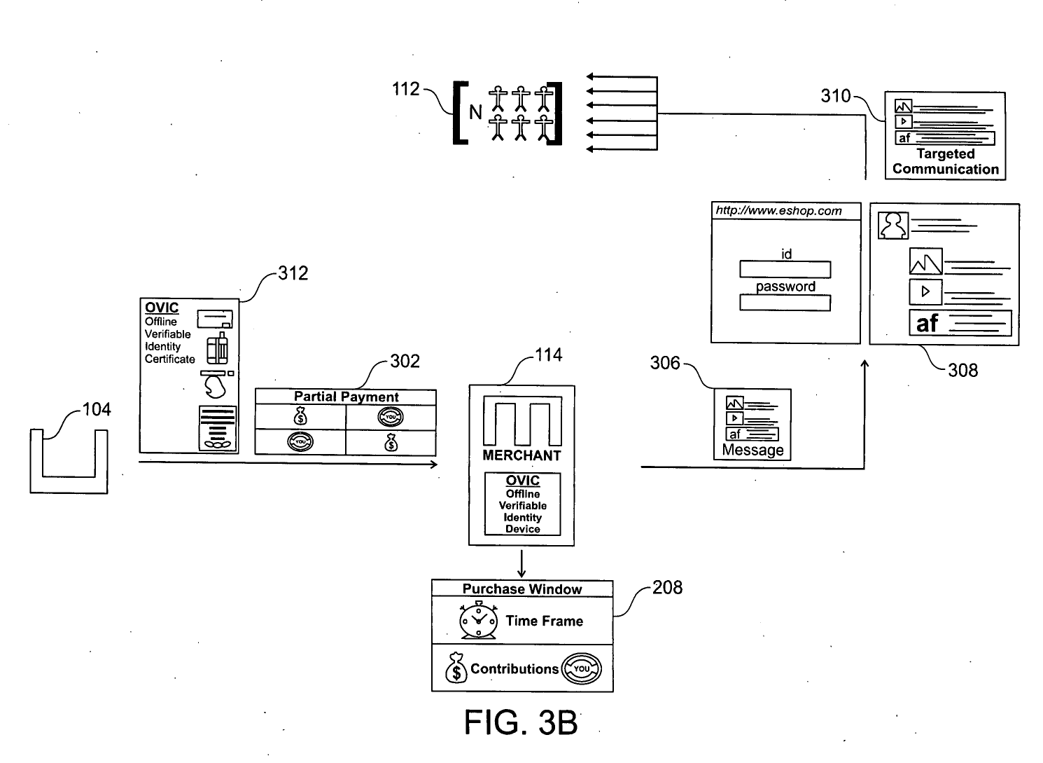

FIG. 3A illustrates interaction of the first user 104 with the e-commerce electronic entity 116 to initiate the purchase, in accordance with an exemplary embodiment of the present technology. The processor 204 (not shown in FIG. 3A) receives the first payment 302 (as described in FIGS. 1 and 2) through the initiation source 206 using an online identifier 304 associated with the first user 104. The first payment 302 is stored in the virtual escrow 210 (not shown in the FIG. 3A). In an embodiment, the processor 204 may set a minimum payment limit for the first payment 302 dependent on the purchase value. For example, the first user 104 may be asked to make a minimum first payment 302 of ten percent of the purchase value to initiate the framework of social payment. In another embodiment, the processor 204 may initiate the social payment with the first payment 302 of zero amount. In such a scenario, the complete payment is made by the group of users 112 by the one or more subsequent part-payments.

In an embodiment, the online identifier 304 of the first user 104 is corresponding to communication link as described in FIG. 1. Examples of the communication link may include, but are not limited to, online community, web portal, social network, email service, blogs, photo and video sharing environment, SMS, web site or any similar electronic service. The first user 104 is linked to the group of users 112 through the communication link. The processor 204 creates the purchase window 208 in response to receipt of the first payment 302. The purchase window 208 includes the one or more options for the at least one user of the group of users 112 to make the one or more subsequent part-payments. The one or more options are derived from the one or more rules (as described in FIG. 2). For example, the processor 204 determines the timeframe for maintaining the purchase window 208 based on the one or more rules. The timeframe can be defined for some hours or some days, in accordance with an embodiment of the technology.

In an embodiment, the processor 204 causes to share information associated with the purchase and the first payment 302 with at least one user of the group of users 112 through a first message 306. The first message 306 is posted on a user profile page 308 of the first user 104. The user profile page 308 is hosted on the communication link, through which the first user 104 is communicatively linked with the group of users 112. The processor 204 utilizes the online identifier 304 (shown as “extended online identity”) in posting the first message 306 on the user profile page 308. Further, a first targeted communication 310 is sent by the processor 204 to the at least one user of the group of users 112. The processor 204 sends the first targeted communication 310 via the communication link or the purchase window 208. Further, the first targeted communication 310 includes the information associated with the purchase and the first payment 302. The first user 104 can define and control the number of users in the group of users 112, with whom the information about the purchase and the first payment 302 is shared. Further, the first user 104 may permit or prohibit any user to be a part of the group of users 112. Hence, a framework for the social payment is set via the electronic entity 116. In an embodiment, the first message 306 and the first targeted communication 310 include information of at least one of details of the at least one user of the group of users 112 that are allowed to make the one or more subsequent part-payments, details of the pending amount to complete the purchase, time remaining in the expiration of the timeframe for the maintenance of the purchase window 208, the unique code assigned to the social payment, and details of the one or more options included in the purchase window 208 for the group of users 112 for the social payment.

FIG. 3B illustrates interaction of the first user 104 with the merchant establishment 114 to initiate the purchase, in accordance with an exemplary embodiment of the present technology. The processor 204 (not shown in FIG. 3b) receives the first payment 302 (as described in FIGS. 1 and 2) through the initiation source 206 using an offline identifier 312 associated with the first user 104. The first payment 302 is stored in the virtual escrow 210 (not shown in the FIG. 3B). In an embodiment, the processor 204 may set a minimum payment limit for the first payment 302 dependent on the purchase value. For example, the first user 104 may be asked to make a minimum first payment 302 of ten percent of the purchase value to initiate the framework of social payment. In another embodiment, the processor 204 may initiate the social payment with the first payment 302 of zero amount. In such a scenario, the complete payment is made by the group of users 112 by the one or more subsequent part-payments.

In an embodiment, the offline identifier 312 of the first user 104 corresponds to communication link as described in FIG. 1. Examples of the communication link may include, but are not limited to, online community, web portal, social network, email service, blogs, photo and video sharing environment, SMS, web site or any similar electronic service. The first user 104 is linked to the group of users 112 through the communication link. The processor 204 creates the purchase window 208 in response to receipt of the first payment 302. The purchase window 208 includes the one or more options for the at least one user of the group of users 112 to make the one or more subsequent part-payments. The one or more options are derived from the one or more rules (as described in reference to FIG. 2). For example, the processor 204 determines the timeframe for maintaining the purchase window 208 based on the one or more rules.

In an embodiment, the processor 204 causes to share information associated with the purchase and the first payment 302 with at least one user of the group of users 112 through a first message 306. The first message 306 is posted on a user profile page 308 of the first user 104. The user profile page 308 is hosted on the communication link, through which the first user 104 is communicatively linked with the group of users 112. The processor 204 utilizes the online identifier 304 in posting the first message 306 on the user profile page 308. Further, a first targeted communication 310 is sent by the processor 204 to the at least one user of the group of users 112. The processor 204 sends the first targeted communication 310 via the communication link or the purchase window 208. Further, the first targeted communication 310 includes the information associated with the purchase and the first payment 302. The first user 104 can define and control the number of users in the group of users 112, with whom the information about the purchase and the first payment 302 is shared. Further, the first user 104 may permit or prohibit any user to be a part of the group of users 112. Hence, a framework for the social payment is set via the merchant establishment 114. In an embodiment, the first message 306 and the first targeted communication 310 include information of at least one of details of the at least one user of the group of users 112 that are allowed to make the one or more subsequent part-payments, details of the pending amount to complete the purchase, time remaining in the expiration of the timeframe for the maintenance of the purchase window 208, the unique code assigned to the social payment, and details of the one or more options included in the purchase window 208 for the group of users 112 for the social payment.

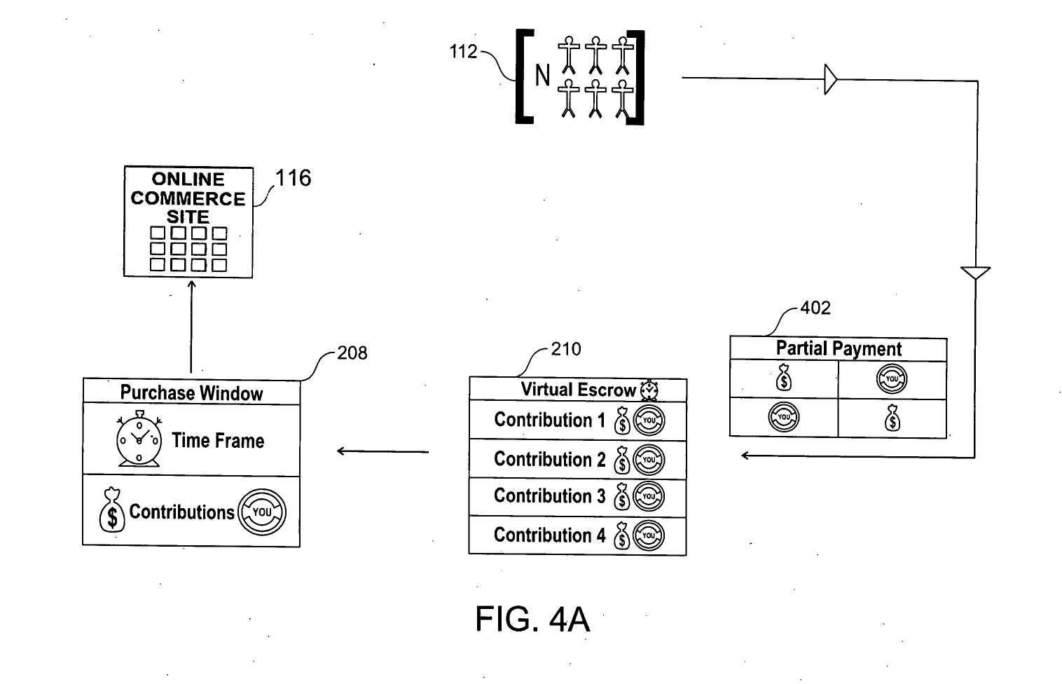

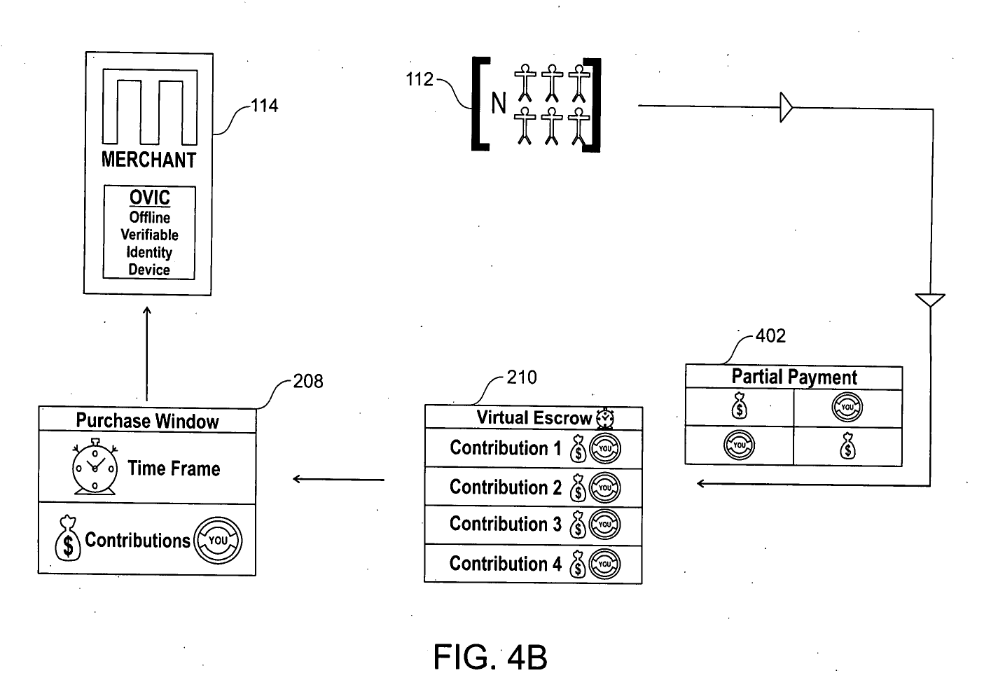

FIGS. 4A and 4B illustrate management of the virtual escrow 210 created based on interaction of the first user 104 with the e-commerce electronic entity 116 and the merchant establishment 114 respectively, in accordance with an exemplary embodiment of the present technology. As described in FIG. 2, the processor 204 creates the virtual escrow 210 once the purchase window 208 is created. Subsequently, the processor 204 causes to share information associated with the purchase and the first payment 302 with at least one user of the group of users 112 through the message 306, as described in FIGS. 3A and 3B. Thereafter, a subsequent payment 402 (for example, a second payment succeeding the first payment, shown as “partial payment 402” in FIGS. 4A and 4B) is received by the processor 204 from a subsequent user. The subsequent user is among the at least one user from the group of users 112 (other than the first user), who receives the information associated with the purchase and the first payment 302. It should be noted that the subsequent payment 402 may be a subsequent part-payment, and may be interchangeably referred to as a ‘subsequent part-payment’.

In an embodiment, the subsequent part-payment 402 (for example, the second part-payment) is stored in the virtual escrow 210 along with the first payment 302 till the purchase is complete. The processor 204 causes the virtual escrow 210 to share the information of the subsequent payment 402 with the purchase window 208. Further, the processor 204 sends the information of the subsequent payment 402 through the purchase window 208 to at least one of the memory 202, the initiation source 206, the at least one user of the group of users 112, the electronic entity 116 (shown as “online commerce site”)/the merchant establishment 114 (shown as “merchant”), the communication link hosting the user profile page 308, and the first user 104. Subsequently, other users may make respective one or more subsequent part-payments (for example, the third part-payment, the fourth part-payment, and so on). However, in an embodiment, one or more users of the group of users 112 may also decide not to participate in the social payment. The virtual escrow 210 stores all the one or more subsequent part-payments received from the group of users 112 along with the first payment 302 till the purchase is complete. Further, the virtual escrow 210 frequently shares the status of the social payment with the purchase window 208. The frequency of sharing the information can be pre-defined by the first user 104 or the processor 204 within the timeframe for maintaining the purchase window 208. Further, the frequency of sharing the information may depend on the one or more part-payments received from the group of users 112.

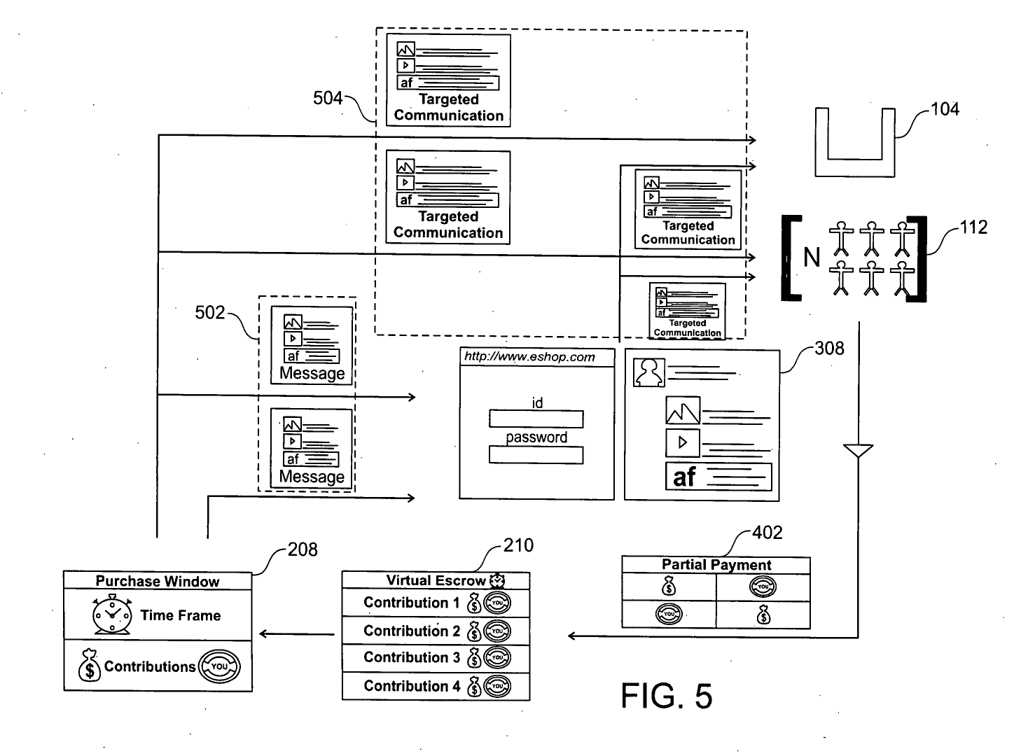

FIG. 5 illustrates progress of the social payment, in accordance with an exemplary embodiment of the present technology. In an embodiment, the processor 204 sends the information of the subsequent payment 402 (through the purchase window 208) to at least one of the memory 202, the initiation source 206, the at least one user of the group of users 112, the electronic entity 116/the merchant establishment 114, the communication link hosting the user profile page 308, and the first user 104. The information is sent by the processor 204 by one or more messages 502 and one or more targeted communications 504. The processor 204 causes the purchase window 208 to frequently post the one or more messages 502 on the user profile page 308 of the first user 104. Further, the one or more targeted communications 504 are sent by the processor 204 to at least one of the memory 202, the initiation source 206, the at least one user of the group of users 112, the electronic entity 116 the merchant establishment 114, and the first user 104. The processor 204 sends the one or more targeted communications 504 via the communication link or the purchase window 208. The one or more messages 502 and the one or more targeted communications 504 include information of at least one of the one or more subsequent part-payments received by the group of users 112, details of the at least one user of the group of users 112 who made the one or more subsequent part-payments, details of the pending amount to complete the purchase, time remaining in the expiration of timeframe for the purchase window 208, the unique code assigned to the social payment, and details of the one or more options for the group of users 112 for the social payment.

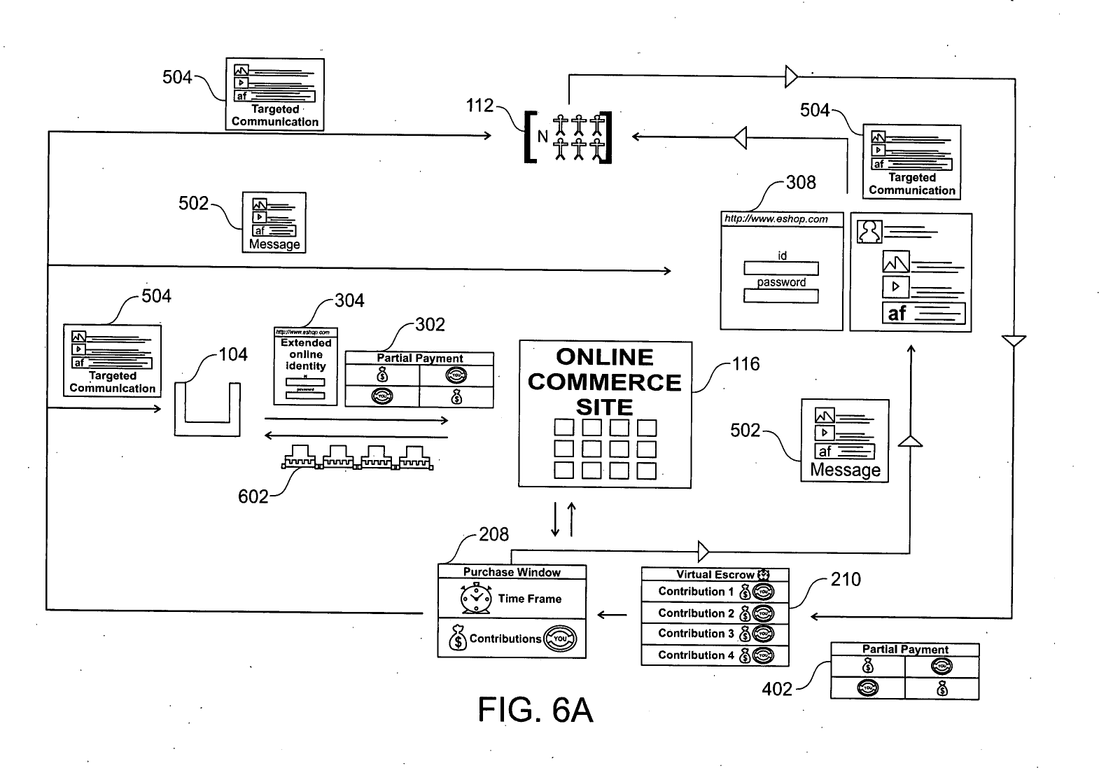

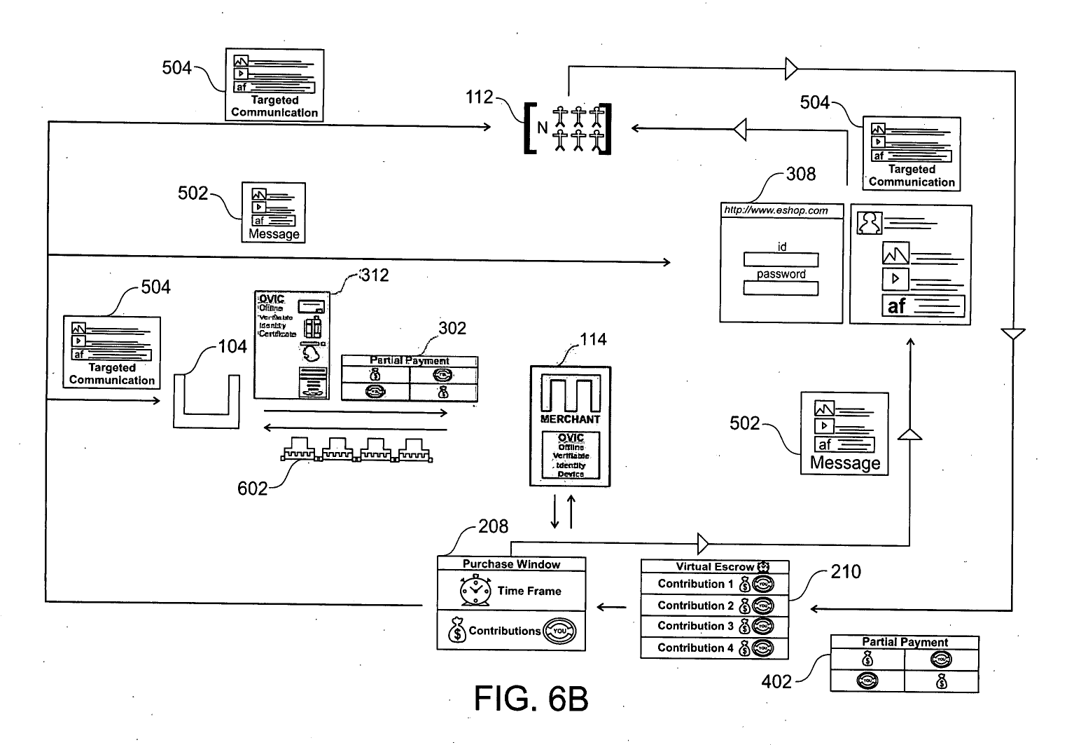

FIGS. 6A and 6B illustrate schematic representations of successful purchases from the e-commerce electronic entity 116 and the merchant establishment 114 respectively, in accordance with an exemplary embodiment of the present technology. The first user 104 and the subsequent user (for example, at least one user of the group of users 112 other than the first user) contribute to the social payment as described in reference to the preceding figures. The purchase transaction can be an e-commerce, offline purchase transaction or a mobile commerce of at least one of an item, product, service, and the like. In an embodiment, the first user 104 may define or may cause the at least one user of the one or more users 112 to define the beneficiary/recipient of the purchase of the product/service 602 by the social payment. The recipient could be at least one of himself/herself, one or more users of the group of users 112 participating in the social payment, and any person or establishment not within the network 102. For example, the first user 104 and the at least one user of the group of users 112 may participate in the social payment to offer a gift to any other user. In an embodiment, the non-recipient would be benefitted by bonus or loyalty points or rewards awarded by at least one of the merchant establishment 114, the electronic entity 116, and the payment gateway 118 for participation in the social payment. The bonus or loyalty points can be later redeemed by the respective user of the group of users 112 for a purchase. Accordingly, the e-commerce electronic entity 116 or the merchant establishment 114 provides purchased product/service 602 to the recipient when it is established that the purchase is completed.

In an embodiment, the completion of the purchase is established by the virtual escrow 210 when the amount corresponding to the purchase value is received by combination of the first payment 302, and the one or more subsequent part-payments by the at least one user of the group of users 112. Additionally, the virtual escrow 210 establishes the completion of the purchase if the purchase amount is received within the timeframe of the purchase window 208. Thereafter, the virtual escrow 210 submits the purchase amount with the merchant establishment 114 and/or the electronic entity 116. In an embodiment, the first user 104 can complete the purchase by making a payment for the balance amount remaining after the combination of the first payment 302, and the one or more subsequent part-payments by the at least one user of the group of users 112. In another embodiment, the first user 104 can empower the processor 204 to auto-deduct the balance amount from the same mode of the first payment 302, such as credit card or debit card payment, to complete the purchase. The first user 104 can set the one or more rules of auto-deduction of the balance amount before or during the social payment. The auto-deduction of the balance amount can be initiated when at least one of following is satisfied, the one or more part-payments by every user of the group of users 112 does not complete the payment and, the timeframe defined for the purchase window 208 is about to expire. For example, the first user 104 can pre-define a time period before the expiration of the purchase window 208 for auto-deduction of the balance amount.

The virtual escrow 210 updates the purchase window 208 for completion of the purchase. Thereafter, the processor 204 causes the purchase window 208 to share the information of completed purchase to at least one of the memory 202, the initiation source 206, the at least one user of the group of users 112, the electronic entity 116 the merchant establishment 114, and the first user 104. The purchase window 208 updates for the completion of purchase by the one or more messages 502 and the one or more targeted communications 504 as described in FIG. 5. For example, if the virtual escrow 210 establishes that the subsequent payment 402 completes the purchase, then the information of completed purchase is shared as described above.

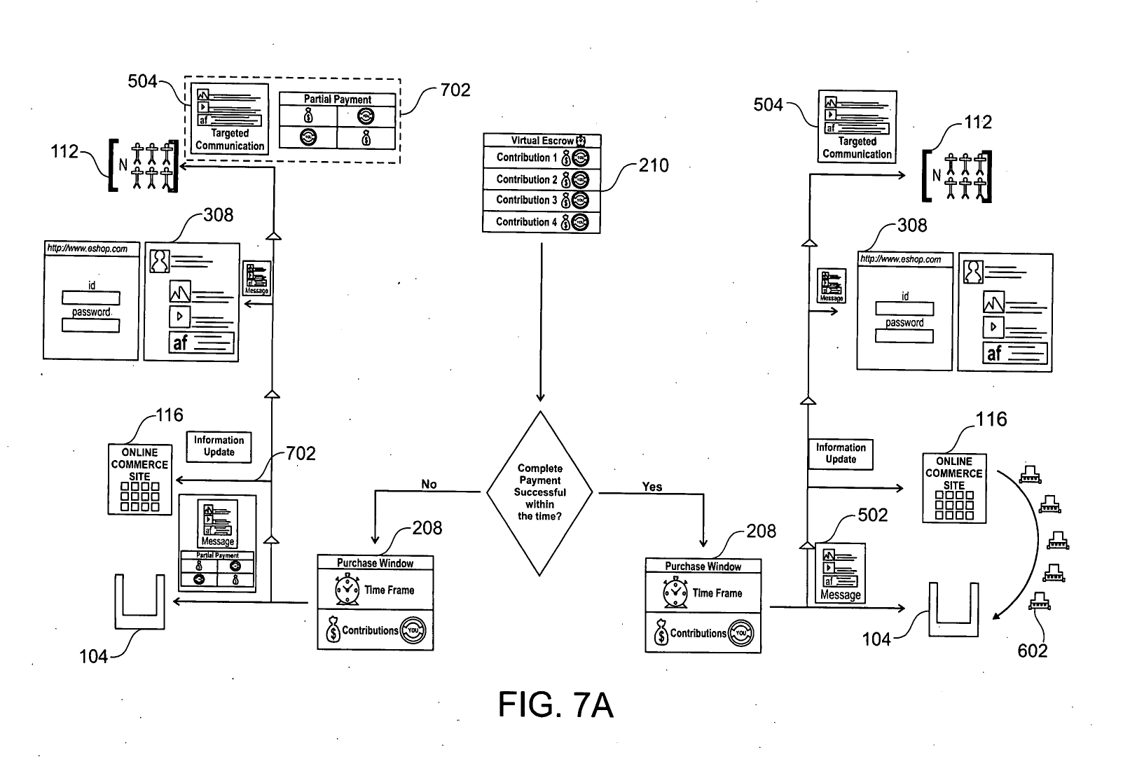

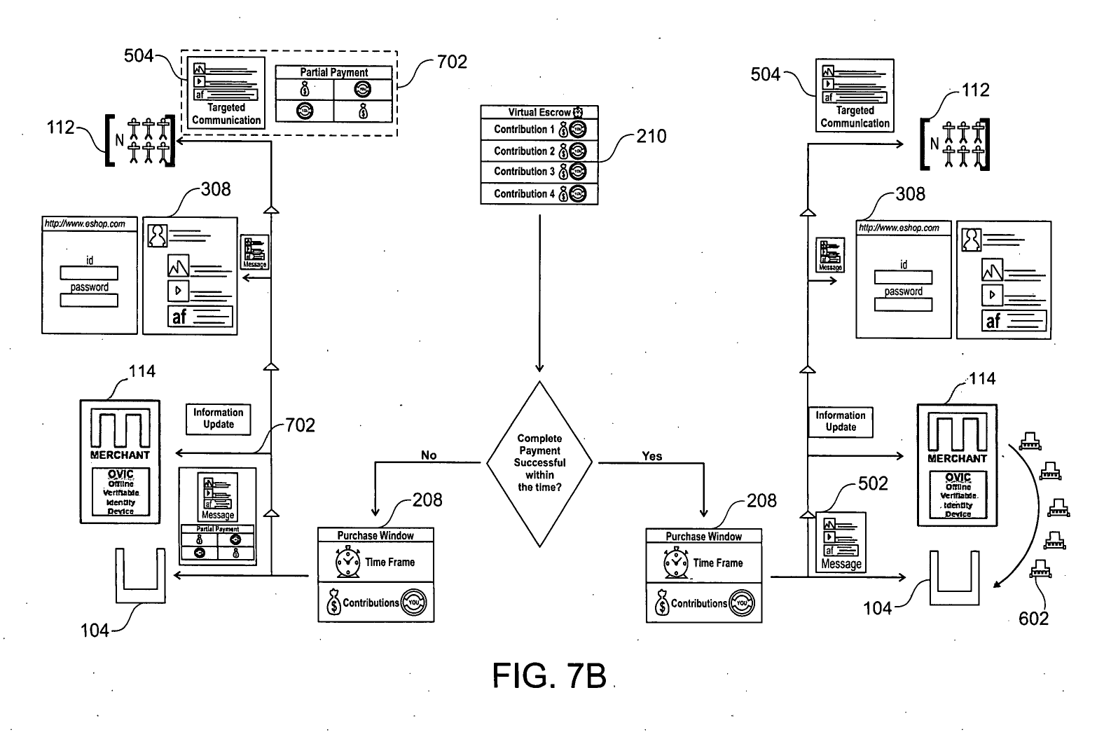

FIGS. 7A and 7B illustrate success or failure of purchase from the e-commerce electronic entity 116 and the merchant establishment 114 respectively, in accordance with an exemplary embodiment of the present technology. As described in FIGS. 6A and 6B, the virtual escrow 210 establishes the success or failure of the social payment based on the timeframe of the purchase window 208 and the purchase amount received by combination of the first payment 302, and the one or more subsequent part-payments by the at least one user of the group of users 112. The social payment is considered as successful if the complete purchase amount is received within the timeframe of the purchase window 208. Otherwise, the social payment is considered to be failed.

In an embodiment, when the social payment is successful, the recipient receives the purchased product/service 602. Further, the virtual escrow 210 submits the purchase amount with the merchant establishment 114 and/or the electronic entity 116 as described in the FIGS. 6A and 6B. During the course of social payment, when the timeframe of the purchase window 208 is not expired, the virtual escrow 210 frequently updates the purchase window 208 regarding the status of social payment. Further, the processor 204 causes the purchase window 208 to share the status of the social payment to at least one of the memory 202, the initiation source 206, the at least one user of the group of users 112, the electronic entity 116 the merchant establishment 114, the communication link hosting the user profile page 308, and the first user 104. The status of the social payment is send by one or more messages 502 and one or more targeted communications 504 as defined in FIG. 5. The one or more messages 502 and the one or more targeted communications 504 include information of at least one of the one or more subsequent part-payments received by the group of users 112, details of the at least one user of the group of users 112 who made the one or more part-payments, details of the pending amount to complete the purchase, time remaining in the expiration of timeframe for the purchase window 208, the unique code assigned to the social payment, and details of the one or more options for the group of users 112 for the social payment.

In an embodiment, the social payment is considered as failed if the complete payment is not received by the virtual escrow 210 even after the expiration of timeframe for the purchase window 208. The virtual escrow 210 updates the purchase window 208 about the failure of the social payment. Further, the processor 204 causes the purchase window 208 to share the information of failure of the social payment to at least one of the memory 202, the initiation source 206, the at least one user of the group of users 112, the electronic entity 116, the merchant establishment 114, the communication link hosting the user profile page 308, and the first user 104. Thereafter, the virtual escrow 210 returns (via the purchase window 208) the first payment 302 amount, and the one or more subsequent part-payments amount to the first user 104, and the respective at least one user of the group of users 112 (associated with the subsequent part-payments), respectively. The amount is returned by one or more return payments 702. In an embodiment, the first user 104 may cancel the social payment before the expiration of the timeframe. The processor 204 causes the purchase window 208 to return the first payment 302, and the one or more subsequent part-payments to the first user 104 and the one or more subsequent users of the group of users 112, respectively. Further, in an example, the payment gateway 118 may deduct penalty for an early withdrawal either from the first payment 302 or the rest of the contribution by the at least one user of the group of users 112.

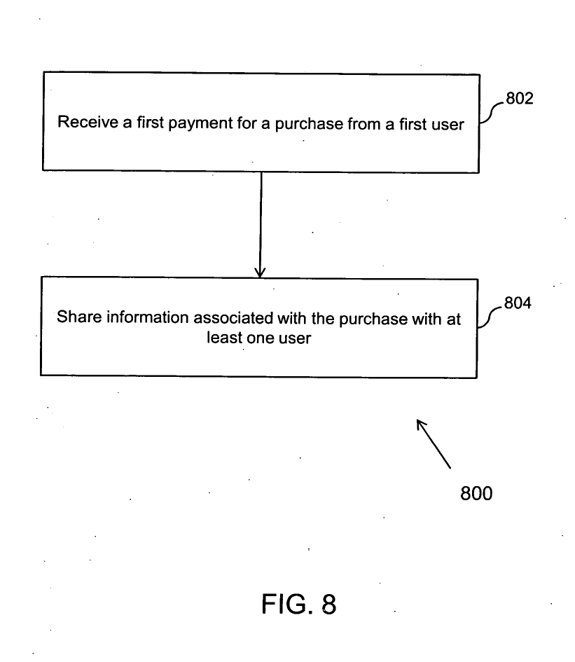

FIG. 8 is a flowchart depicting a method 800 of the social payment, in accordance with an exemplary embodiment of the present technology. The method 800 depicted in the flow chart may be executed in various scenarios, for example in the environment 100 and/or by the system 200. Further, the method 800 may be executed by a processing system, for example, the processor 204 and/or the payment gateway 118 as described in the reference to the preceding FIGS. 2 to 7B. Operations of the flowchart, and combinations of operation in the flowchart, may be implemented by various means, such as hardware, firmware, computing device, circuitry and/or other device associated with execution of software including one or more computer program instructions of the processor 204 or the payment gateway 118.

At block 802, a processor such as the processor 204 receives the first payment 302 for the purchase from the first user 104. The first payment 302 comprises a partial payment, an amount less than the purchase amount, for the purchase. The purchase transaction can be at least one of an e-commerce, offline purchase transaction and mobile commerce of at least one of an item, product, service, and the like. The purchase can be through at least one of a seller site, a bid during an auction, a bid during a reverse auction, blind bids, and the like. The first payment 302 is initiated at at least one of the merchant establishment 114 or the electronic entity 116, and both are communicatively linked to the network 102 through the payment gateway 118.

At block 804, the processor electronically shares information associated with the purchase, with the at least one user of the group of users 112, to inform the at least one user of the group of users 112 about incomplete payment for the purchase. The first user 104 is socially linked to the group of users 112, such as colleagues, friends, relatives, friends on any social network friend, and the like. Further, the first user 104 is communicatively linked to the group of users 112. Examples of the communication link may include, but are not limited to, online community, web portal, social network, email service, blogs, photo and video sharing environment, SMS, web site or any similar electronic service. Further, the first user 104 and the group of users 112 are communicatively linked with the network 102 through one or more electronic devices. Examples of electronic devices may include, but are not limited to, mobile, laptop, desktop, tablet, personal digital assistance device, palmtop, and the like. The number of users in the group of users 112 can be defined and controlled by the first user 104. Further, the first user 104 may permit or prohibit any user to be a part of the group of users 112.

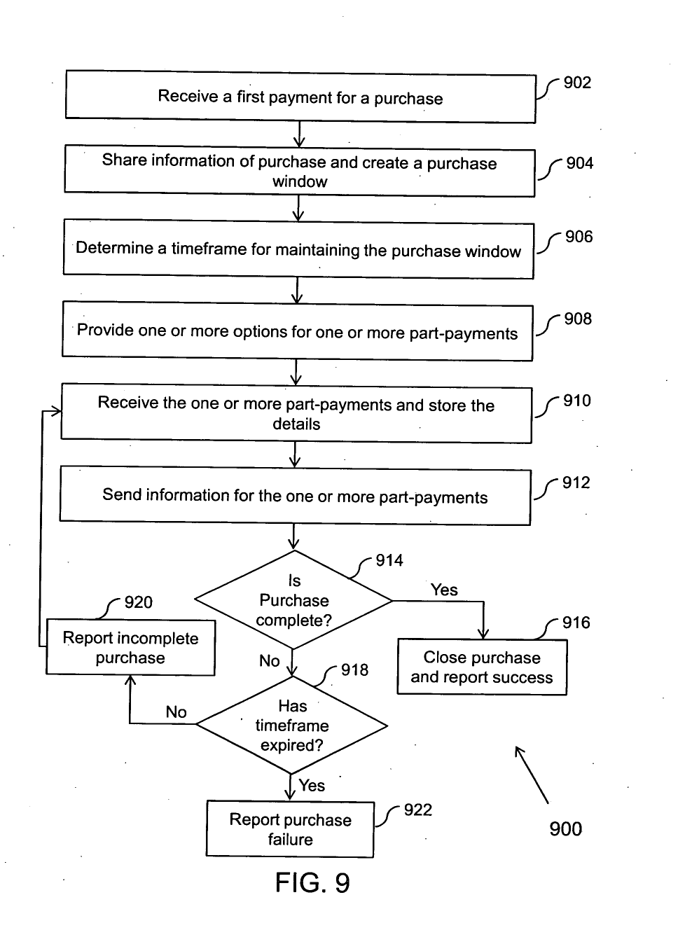

FIG. 9 is a flowchart depicting an exemplary method 900 of the social payment, in accordance with another exemplary embodiment of the present technology. The method 900 depicted in the flow chart may be executed in various scenarios, for example the environment 100 and/or the system 200. Further, the method 900 may be executed by a processing system, for example, the processor 204 and/or the payment gateway 118 as described in reference to the preceding FIGS. 2 to 7B. Operations of the flowchart, and combinations of operation in the flowchart, may be implemented by various means, such as hardware, firmware, computing device, circuitry and/or other device associated with execution of software including one or more computer program instructions of the processor 204 or the payment gateway 118.

At block 902, a processor such as the processor 204 receives the first payment 302 for a purchase. In an embodiment, the first payment is received from a first user such as the first user 104. The first payment 302 comprises a partial payment, an amount less than the purchase amount, for the purchase. As described in reference to preceding figures, the first payment 302 is initiated at at least one of the merchant establishment 114 or the electronic entity 116, where both are communicatively linked to the network 102 through the payment gateway 118. In an embodiment, the first payment 302 can be done by any one or combination of different modes of payment available to the first user 104. Examples of the different modes of payment may include, but are not limited to, credit card, debit card, online bank transfers, or even cheques, cash, or redemption of virtual credits, merchant credit notes, marketplace credits, discount vouchers, loyalty points, digital currencies or virtual monies. The first payment 302 is initiated using the initiation source 206. The initiation source 206 may be a point of sale of the merchant establishment 114 or the electronic entity 116, where the first user 104 can make the first payment 302 by any mode of payment described above.

At block 904, the processor 204 electronically shares information associated with the purchase and created a purchase window. In an embodiment, the method 900 include sharing the information with the at least one user of the group of users 112, to inform the at least one user of the group of users 112 about incomplete payment for the purchase. In an embodiment, the information is shared using the first message 306 and the first targeted communication 308, as described in FIGS. 3A and 3B. The first user 104 is socially linked to the group of users 112, such as colleagues, friends, relatives, friends on any social network friend, and the like. Further, the first user 104 is communicatively linked to the group of users 112. Examples of the communication link may include, but are not limited to, online community, web portal, social network, email service, blogs, photo and video sharing environment, SMS, web site or any similar electronic service. Further, the first user 104 and the group of users 112 are communicatively linked with the network 102 through one or more electronic devices. Examples of electronic devices may include, but are not limited to, mobile, laptop, desktop, tablet, personal digital assistance device, palmtop, and the like. The number of users in the group of users 112 can be defined and controlled by the first user 104. Further, the first user 104 may permit or prohibit any user to be a part of the group of users 112.

The first payment 302 is received by the processor 204 using an identifier associated with the first user 104. Further, the information associated with the purchase is shared with at least one user of the group of users 112 on a electronic entity 116 using the identifier. Thereafter, the processor 204 creates a purchase window such as the purchase window 208 in response to receipt of the first payment 302 through the initiation source 206. The processor 204 additionally creates the virtual escrow 210 once the purchase window 208 is created.

At block 906, the method 900 includes determining the timeframe for maintaining the purchase window 208. In an embodiment, the timeframe is determined based on the one or more rules. The first user 104 can define and store the one or more rules for the one or more subsequent part-payments by at least one user of the group of users 112 in the memory 202 for successful social payment. Examples of the one or more rules may include, but are not limited to, the timeframe for maintaining the purchase window 208, number and identification of users in the group of users 112 to participate in the social payment, number of times the at least one user of the group of users 112 can contribute, fixed amount of allowable one or more subsequent part-payments by the at least one user of the group of users 112, minimum or maximum amount for the one or more subsequent part-payments by the at least one user of the group of users 112, modes and/or one or more possibility of the one or more subsequent part-payments by the at least one user of the one or more users 112, closure of the complete payment, auto-deduct to complete the payment, and beneficiary/recipient of the purchase. In an embodiment, the processor 204 may define the one or more rules. Further embodiments of the one or more rules are provided in the preceding figures.

At block 908, the processor 204 provides one or more options (through the purchase window 208) for the one or more subsequent part-payments to at one user of the group of users 112, hence setting the framework for social payment. In an embodiment, the one or more options are derived from the one or more rules. At block 910, the processor 204 receives the one or more subsequent part-payments 402 (shown as partial payment in the FIGS. 4A and 4b) from the at least one user of the group of users 112. For example, the processor 204 receives the subsequent payment 402, for example, a second payment from a second user of the group of users 112, and a third payment from a third user of the group of users 112. Further, the subsequent payment (for example, the second part-payment) is stored in the virtual escrow 210 along with the first payment 402. The virtual escrow 210 is used to hold the first payment 302 and the one or more subsequent part-payments (for example, the second and third part-payments) by the at least one user of the group of users 112 till the purchase is completed. For instance, in an example, second, third, and a fourth part-payment may be performed by users, respectively in order to complete the purchase. However, in an embodiment, one or more users of the group of users 112 may also decide not to participate in the social payment.

The processor 204 causes the virtual escrow 210 to share the information of the subsequent payment 402 with the purchase window 208. Further, at 912, the processor 204 sends the information of the subsequent payment 402 (for example, second part-payment, third part-payment, and so on) through the purchase window 208 to at least one of the memory 202, the initiation source 206, the at least one user of the group of users 112, the electronic entity 116, the merchant establishment 114, the communication link hosting the user profile page 308, and the first user 104. It should be noted that at least one user of the group of users 112 may make respective one or more subsequent part-payments. Further, the virtual escrow 210 frequently shares the status of the social payment (including the one or more subsequent part-payments) with the purchase window 208 as described in FIGS. 4A, 4B and 5. The frequency of sharing the information can be pre-defined by the first user 104 or the processor 204 within the timeframe for maintaining the purchase window 208. Further, the frequency of sharing the information may depend on the one or more subsequent part-payments received from the group of users 112.

At block 914, the processor 204 causes the virtual escrow 210 to determine whether the purchase is complete. The virtual escrow 210 determines the completion of purchase after each of the one or more subsequent part-payments and at the pre-defined frequency described with reference to block 912. In case the purchase is completed, the virtual escrow 210 closes the purchase at block 916. The virtual escrow 210 updates the purchase window 208 for completion of the purchase. Thereafter, the processor 204 causes the purchase window 208 to share the information of completed purchase to at least one of the memory 202, the initiation source 206, the at least one user of the group of users 112, the electronic entity 116, the merchant establishment 114, and the first user 104. The purchase window 208 updates for the completion of purchase by the one or more messages 502 and the one or more targeted communications 504 as described in FIG. 5. For example, if the virtual escrow 210 establishes that the subsequent payment (for example, second, third, or any other subsequent part-payment) 402 completes the purchase, then the information of completed purchase is shared as described above. Additionally, the steps and embodiments described in the FIGS. 6A and 6B for the successful purchase are performed.

In case the purchase is not completed, the virtual escrow 210 determines whether the timeframe defined for maintenance of the purchase window 208 has expired, at block 918. In case the timeframe has not expired, the virtual escrow 210 establishes that the purchase is incomplete. The virtual escrow 210 updates the purchase window 208 for incomplete purchase. Thereafter, at block 920, the processor 204 causes the purchase window 208 to share the information of incomplete purchase to at least one of the memory 202, the initiation source 206, the at least one user of the group of users 112, the electronic entity 116, the merchant establishment 114, and the first user 104. The method 900 thereafter repeats iteratively from the block 910. For instance, a subsequent part-payment is again received at the block 910, and the operations at the blocks 910 to 920 are performed, till the purchase is detected as complete at the block 914, and the purchase is thereafter closed at the block 916.

In case the timeframe has expired, the virtual escrow 210 establishes that the purchase is failed. At block 922, the virtual escrow 210 updates the purchase window 208 for failed purchase. Thereafter, the processor 204 causes the purchase window 208 to share the information of failed purchase to at least one of the memory 202, the initiation source 206, the at least one user of the group of users 112, the electronic entity 116, the merchant establishment 114, and the first user 104. Additionally, the steps and embodiments described in the FIGS. 7a and 7b for the failed purchase are performed.

Various embodiments, as discussed above, provide method and system of social payment. For example, if the first user 104, named Dan, triggers a social purchase window 208 on the electronic entity 116 named ‘Social-Network-XY’. For further illustration of this example, say Dan decides to buy a pair of shoes for $100 from a shoe firm called Shoe-Firm-ZYX. For this purpose, he initiates a social payment using his credit card to make the first payment 302 of $10, and then invites all his friends to participate in the social payment. In conventional e-commerce, Dan would have paid $100 to Shoe-Firm-ZYX; but in social payment context created by various embodiments of the present technology, he pays only $10. The money does not move from the point of origin, which is Dan's credit card, directly to Shoe-Firm-ZYX; but instead gets locked in a virtual escrow 210 that gets created simultaneous to the triggering of the first payment 302.

The Virtual Escrow 210, for example, named: ‘Social-Network-XY-Shoe-Firm-ZYX-Dan-Nov-23-12345’ is given a unique code identity,

‘56748PLOIKMM84’ contains all the details of the transactions, including the first user 104, product recipient, timeframe of the purchase window 208, target payment and current status of contribution. The $10 is transferred on behalf of Shoe-Firm-ZYX to the virtual escrow 210 from Dan's account and held there till the Social Purchase is closed. If the social payment is successfully completed with other friends of Dan contributing the remaining $90, the total of $100 is transferred to Shoe-Firm-ZYX from the virtual escrow 210. Otherwise, the funds are returned to respective contributor, including Dan. Dan gets either his $10 or $9.50 (in case of penalty clause for a failed social payment.

The ‘Social-Network-XY’ has to create merchant banking account for it to receive payments. In an embodiment, the received monies are tracked by this account, and create multiple sub-accounts in the same banking account as the virtual escrow 210 accounts. Further, all payments made towards social payment by any numbers of users is shown as being credited to this account. However, the present technology tracks each social payment as being banked to this account, with the virtual escrow 210. Common forms of non-transitory computer-readable storage medium include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer may read.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A method comprising:
receiving a first payment for a purchase from a first user, the first payment comprising a partial payment for the purchase; and
electronically sharing information associated with the purchase with at least one user to inform the at least one user about incomplete payment for the purchase, wherein the at least one user is associated with the first user.

2. The method of claim 1, wherein the first payment is initiated at least one of:
(i) an electronic entity; and
(ii) a merchant establishment.

3. The method of claim 1, wherein:
the receiving comprises receiving an identifier associated with the first user; and the sharing comprises sharing information on an electronic entity using the identifier.

4. The method of claim 1 further comprising:
creating a purchase window in response to receipt of the first payment.

5. The method of claim 4 further comprising:
determining a timeframe for maintaining the purchase window.

6. The method of claim 1 further comprising:
(i) providing option to the at least one user to contribute to payment for the purchase;
(ii) receiving a subsequent payment for the purchase from a subsequent user, wherein the subsequent user is one among the at least one user; and
(iii) storing details of the subsequent payment.

7. The method of claim 6 further comprising:
sending information of the subsequent payment to at least one of a purchase window, an initiation source, the at least one user, an electronic entity using which the information associated with the purchase is shared, and the first user.

8. The method of claim 6 further comprising:
(i) determining if the subsequent payment completes the purchase; and
(ii) sending information of completion of purchase to at least one of a purchase window, an initiation source, the at least one user, an electronic entity using which the information associated with the purchase is shared, and the first user if the subsequent payment completes the purchase.

9. The method of claim 6 further comprising:
(i) determining if the subsequent payment completes the purchase;
(ii) determining if a timeframe associated with the purchase has expired;
(iii) sending information of incomplete purchase to at least one of a purchase window, an initiation source, the at least one user, an electronic entity using which the information associated with the purchase is shared, and the first user if the subsequent payment does not complete the purchase and the timeframe associated with the purchase has not expired; and
(iv) sending information of failure of purchase to at least one of the purchase window, the initiation source, the at least one user, the electronic entity using which the information associated with the purchase is shared, and the first user if the subsequent payment does not complete the purchase and the timeframe associated with the purchase has expired.

10. A non-transitory, computer-readable storage medium storing computer-executable program instructions to implement:
(i) receiving a first payment for a purchase from a first user, the first payment comprising a partial payment for the purchase; and
(ii) causing to share information associated with the purchase with at least one user to inform the at least one user about incomplete payment for the purchase, wherein the at least one user is associated with the first user.

11. The storage medium of claim 10, wherein the first payment is initiated at least one of:
(i) an electronic entity; and
(ii) a merchant establishment.

12. The storage medium of claim 10, wherein:
(i) the receiving comprises receiving an identifier associated with the first user; and
(ii) the sharing comprises sharing information on an electronic entity using the identifier.

13. The storage medium of claim 10, wherein the program instructions are further computer-executable to implement:
creating a purchase window in response to receipt of the first payment.

14. The storage medium of claim 13, wherein the program instructions are further computer-executable to implement:
determining a timeframe for maintaining the purchase window.

15. The storage medium of claim 10, wherein the program instructions are further computer-executable to implement:
(i) causing to provide option to the at least one user to contribute to payment for the purchase;
(ii) receiving a subsequent payment for the purchase from a subsequent user, wherein the subsequent user is one among the at least one user; and
(iii) storing details of the subsequent payment.

16. The storage medium of claim 15, wherein the program instructions are further computer-executable to implement:
sending information of the subsequent payment to at least one of a purchase window, an initiation source, the at least one user, an electronic entity using which the information associated with the purchase is shared, and the first user.

17. The storage medium of claim 15, wherein the program instructions are further computer-executable to implement:
(i) determining if the subsequent payment completes the purchase; and
(ii) sending information of completion of purchase to at least one of a purchase window, an initiation source, the at least one user, an electronic entity using which the information associated with the purchase is shared, and the first user if the subsequent payment completes the purchase.

18. The storage medium of claim 15, wherein the program instructions are further computer-executable to implement:
(i) determining if the subsequent payment completes the purchase;
(ii) determining if a timeframe associated with the purchase has expired;
(iii) sending information of incomplete purchase to at least one of a purchase window, an initiation source, the at least one user, an electronic entity using which the information associated with the purchase is shared, and the first user if the subsequent payment does not complete the purchase and the timeframe associated with the purchase has not expired; and
(iv) sending information of failure of purchase to at least one of the purchase window, the initiation source, the at least one user, the electronic entity using which the information associated with the purchase is shared, and the first user if the subsequent payment does not complete the purchase and the timeframe associated with the purchase has expired.

19. A system comprising:
(i) a memory to store instructions;
(ii) a processor responsive to stored instructions to perform receiving a first payment for a purchase from a first user, the first payment comprising a partial payment for the purchase; and
(iii) cause to share information associated with the purchase with at least one user to inform the at least one user about incomplete payment for the purchase, wherein the at least one user is associated with the first user.

20. The system of claim 19, wherein:
(i) the receiving comprises receiving an identifier associated with the first user; and
(ii) the sharing comprises sharing information on an electronic entity using the identifier.

21. The system of claim 19, wherein the processor further performs:
creating a purchase window in response to receipt of the first payment.

22. The system of claim 21, wherein the processor further performs:
determining a timeframe for maintaining the purchase window.

23. The system of claim 19, wherein the processor further performs:
(i) causing to provide option to the at least one user to contribute to payment for the purchase;
(ii) receiving a subsequent payment for the purchase from a subsequent user, wherein the subsequent user is one among the at least one user; and
(iii) storing details of the subsequent payment.

24. The system of claim 19, wherein the processor further performs:
sending information of the subsequent payment to at least one of a purchase window, an initiation source, the at least one user, an electronic entity using which the information associated with the purchase is shared, and the first user.

25. The system of claim 19, wherein the processor further performs:
(i) determining if the subsequent payment completes the purchase; and
(ii) sending information of completion of purchase to at least one of a purchase window, an initiation source, the at least one user, an electronic entity using which the information associated with the purchase is shared, and the first user if the subsequent payment completes the purchase.

26. The system of claim 19, wherein the processor further performs:
(i) determining if the subsequent payment completes the purchase;
(ii) determining if a timeframe associated with the purchase has expired;
(iii) sending information of incomplete purchase to at least one of a purchase window, an initiation source, the at least one user, an electronic entity using which the information associated with the purchase is shared, and the first user if the subsequent payment does not complete the purchase and the timeframe associated with the purchase has not expired; and
(iv) sending information of failure of purchase to at least one of the purchase window, the initiation source, the at least one user, the electronic entity using which the information associated with the purchase is shared, and the first user if the subsequent payment does not complete the purchase and the timeframe associated with the purchase has expired.
